(19) United States
(12) Patent Application Publication
(10) Pub. No.: US 2008/0152067 A1
(43) Pub. Date: Jun. 26, 2008

(54) Granulation accelerating device and nuclear reactor housing

(75) Inventors: Hiroshi Goda, Tokyo (JP); Yoshinori Yamakoshi, Tokyo (JP); Makoto Yamagishi, Tokyo (JP); Koichi Tanimoto, Hyogo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: MITSUBISHI HEAVY INDUSTRIES, LTD., Tokyo (JP)

(21) Appl. No.: 11/806,321

(22) Filed: May 31, 2007

(30) Foreign Application Priority Data
Dec. 22, 2006 (JP) 2006-346627

(51) Int. Cl. G21C 9/016

(52) U.S. Cl. 376/280

(57) ABSTRACT

A nuclear reactor housing includes a vertically held pressurized water reactor and a cavity formed below the pressurized water reactor. A granulating member is positioned between the pressurized water reactor and the cavity and that accelerates granulation of debris falling from the pressurized water reactor into the cavity.

### BACKGROUND OF THE INVENTION

1. Field of the Invention

The present invention relates to a technology for breaking down debris resulting from a molten core into smaller pieces in case an accident occurs in a nuclear power plant.

2. Description of the Related Art

A pressurized water reactor (PWR) is a type of nuclear power plants. A PWR employs light water as a reactor coolant and a neutron moderator. The light water at a high temperature, but below the boiling temperature, and a high pressure is made to fill a primary loop. The high-temperature and high-pressure light water is made to flow inside a steam generator that generates steam by heat exchange. The steam is used to rotate a turbine generator that generates electricity.

A nuclear reactor housing of the PWR is constructed on a firm ground, such as a rock layer. Moreover, the inside of the PWR is divided into compartments with walls made of, for example, reinforced concrete. These walls form a cylindrical concrete structure that vertically supports a reactor vessel such that a cavity is formed below the reactor vessel at the center inside the nuclear reactor housing. The nuclear reactor houses a certain number of fuel assemblies each made of a plurality of fuel rods and a certain number of control rods, which are interposed between the fuel rods, arranged in a matrix.

In case loss of coolant accident (LOCA) or transient occurs in the nuclear power plant, an emergency-core-cooling system operates to cool down the reactor so that generated heat is reduced to certain extent. However, in case the emergency-core-cooling system breaks down, the nuclear reactor cannot be cooled so that the core that includes fuel assemblies inside the reactor vessel melts. The molten core melts a bottom portion of the reactor vessel, penetrates through the bottom portion, and falls into the cavity along with the bottom portion. Generally, the debris that leaks out of the reactor vessel is received and cooled in the cavity to assure safety. Related technologies have been disclosed in Japanese Patent Publication No. S59-016675 and Japanese Patent Publication Laid-open Nos. S60-047988, S60-047989, and H4-505214 and 2004-117102.

Japanese Patent Publication No. S59-016675 discloses a reactor-core-capturing device that includes a dome funnel member that is configured to receive debris; and a core-fragment vessel that surrounds the dome funnel member and that is formed of bricks. The dome funnel member and the core-fragment vessel are positioned below a reactor vessel. Each of Japanese Patent Application Laid-open Nos. S60-047988 and S60-047989 discloses a cooling device that cools molten core. The cooling device includes a heat pipe for cooling debris; and any one of a vessel and a vessel-shaped heat absorption unit that are configured to receive debris and positioned right below a pressurizing vessel. Japanese Patent Application Laid-open No. H4-505214 discloses a safety device that assures safety of a nuclear reactor plant. The device includes a pool positioned below a reactor vessel and filled with water for granulating and cooling down debris. Japanese Patent Application Laid-open No. 2004-117102 discloses a debris capturing device that includes an air duct, a cavity, and a unit configured to prevent debris from dispersing, all of which are positioned below a reactor vessel.

When any one of the vessels and the unit that are disclosed in Japanese Patent Publication No. S59-016675, and Japanese Patent Application Laid-open Nos. S60-047988 and S60-047989 receives debris, pieces of the debris get combined into one large piece so that the debris cannot be completely cooled easily. Similarly, when the debris falls into the pool disclosed by Japanese Patent Application Laid-open No. H04-505214 or the unit disclosed by Japanese Patent Application Laid-open No. 2004-117102, the debris falls on already existing debris and gets combined into one large piece so that the debris cannot be completely cooled quickly.

### SUMMARY OF THE INVENTION

It is an object of the present invention to at least partially solve the problems in the conventional technology.

According to an aspect of the present invention, a granulation accelerating device includes a granulating unit that is positioned between a nuclear reactor and a cavity and that is configured to granulate debris that falls from a nuclear reactor into the cavity.

According to another aspect of the present invention, a nuclear reactor housing includes a nuclear reactor; a cavity located below the nuclear reactor; and a granulation accelerating unit that is positioned between the nuclear reactor and the cavity and that is configured to accelerate granulation of debris that falls from the nuclear reactor.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic side view of a granulation accelerating device according to a first embodiment of the present invention;

FIG. 2 is a cross section of the granulation accelerating device taken along the line II-II shown in FIG. 1;

FIG. 3 is a cross section of the granulation accelerating device taken along the line III-III shown in FIG. 1;

FIG. 4 is a schematic view of a nuclear power plant that employs the nuclear reactor housing according to the first embodiment;

FIG. 5 is a cut-away view of a reactor core included in a water pressurized reactor;

FIG. 6 is a cross section of the nuclear reactor housing according to the first embodiment;

FIG. 7 is a schematic side view of a granulation accelerating device according to a second embodiment of the present invention;

FIG. 8 is a schematic side view of a modification of the granulation accelerating device according to the second embodiment;

FIG. 9 is a schematic side view of another modification of the granulation accelerating device according to the second embodiment;

FIG. 10 is a schematic side view of a granulation accelerating device according to a third embodiment; and

FIG. 11 is a schematic side view of a granulation accelerating device according to a fourth embodiment of the present invention.

### DETAILED DESCRIPTION OF THE PREFERRED EMBODIMENTS

Exemplary embodiments of the present invention are described in detail below. Note that the invention is not limited to the embodiments.

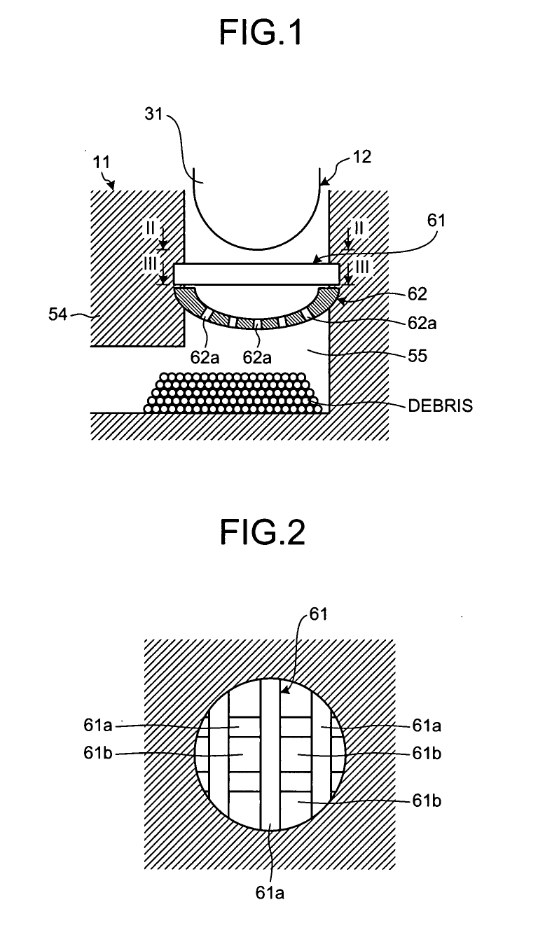

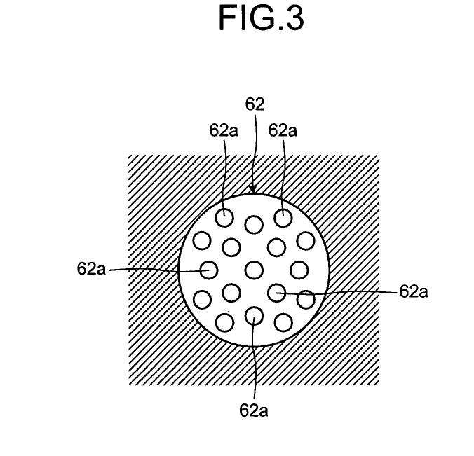

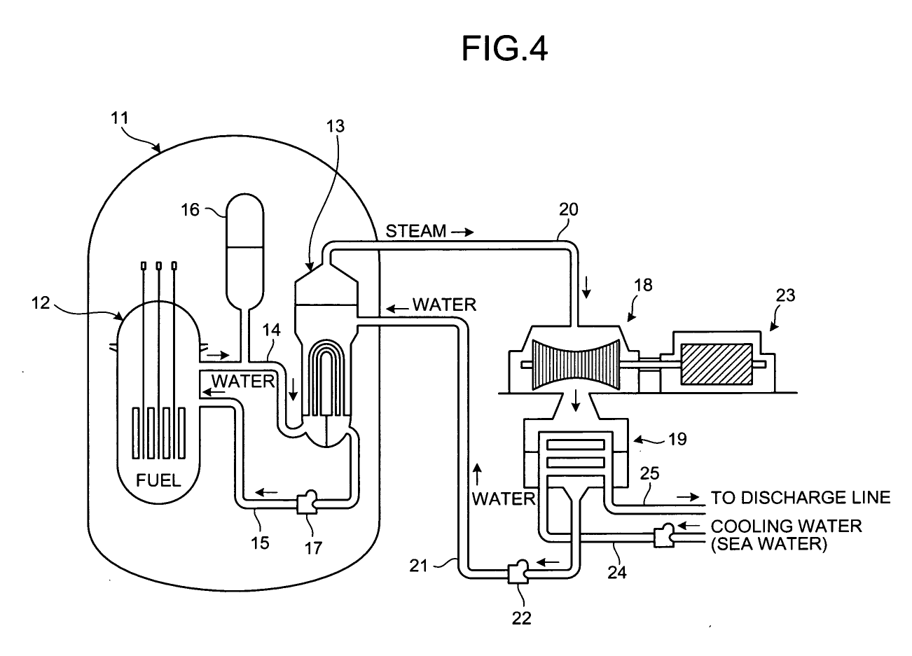

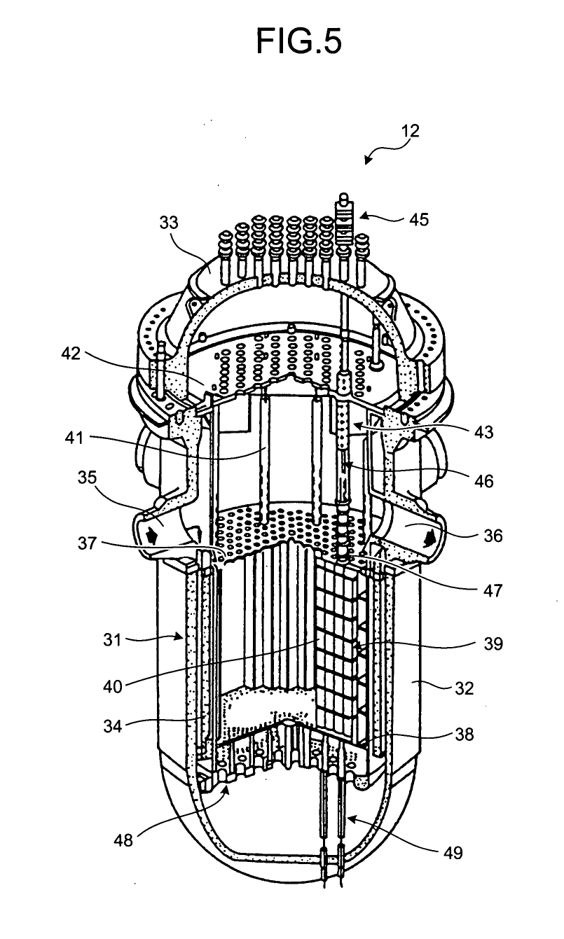

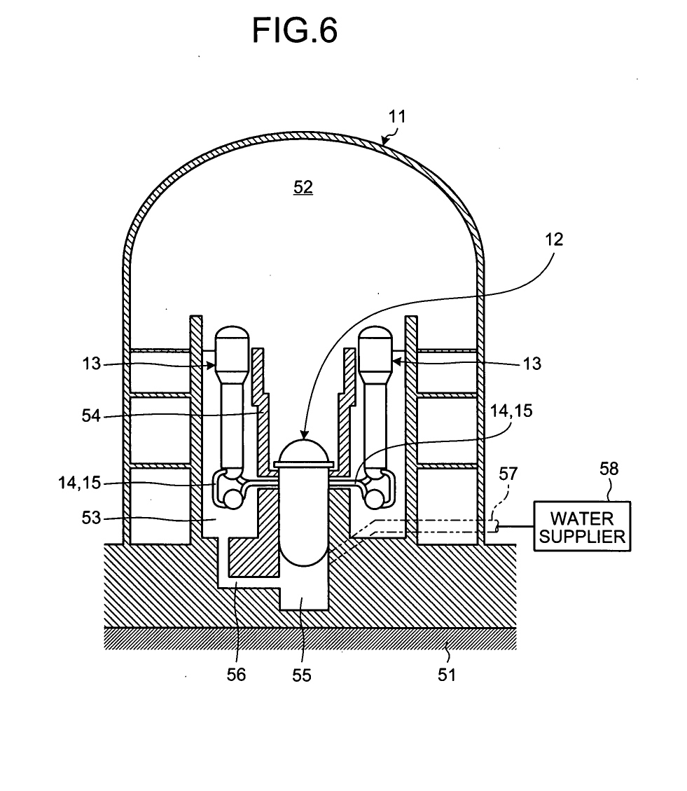

FIG. 1 is a schematic side view of a granulation accelerating device according to a first embodiment of the present invention. The granulation accelerating device is employed for a nuclear reactor housing. FIG. 2 is a cross section of the granulation accelerating device shown in FIG. 1, taken along the line II-II shown in FIG. 1. FIG. 3 is a cross section of the granulation accelerating device shown in FIG. 1, taken along the line III-III shown in FIG. 1. FIG. 4 is a schematic view of a nuclear power plant that employs the nuclear reactor housing according to the first embodiment. FIG. 5 is a cut-away view of a reactor core included in a water pressurized reactor. FIG. 6 is a cross section of the nuclear reactor housing according to the first embodiment.

A pressurized water reactor (PWR) according to a first embodiment of the present invention is employed for a nuclear power plant. The PWR employs light water as a reactor coolant and a neutron moderator. The light water at a high temperature, but below the boiling temperature, and a high pressure is made to fill a primary loop. The high-temperature and high-pressure light water is made to flow inside a steam generator that generates steam by heat exchange. The steam is used to rotate a turbine generator that generates electricity.

Specifically, as shown in FIG. 4, the nuclear power plant includes a nuclear reactor housing 11 that includes a PWR 12 and a steam generator 13. The PWR 12 is connected to the steam generator 13 via coolant lines 14 and 15. The coolant line 14 is provided with a pressurizer 16, and the coolant line 15 is provided with a cooling water pump 17. The PWR 12 employs light water as a moderator and a primary coolant. A primary coolant loop is pressurized by the pressurizer 16 that applies high pressure of approximately 150 barometers to 160 barometers in order to inhibit the primary coolant from boiling in the reactor core. The light water serving as the primary coolant is heated in the PWR 12 by using fuel such as low-enriched uranium or MOX. The resultant high-temperature light water is sent to the steam generator 13 through the coolant line 14 while being maintained in a highly-pressurized state at a certain level. In the steam generator 13, the heat of the high-temperature and high-pressure light water is transferred to a secondary coolant. The cooled light water is then sent back through the coolant line 15 to the PWR 12.

The steam generator 13 is connected to a turbine 18 via a coolant line 20 and connected to a condenser 19 via a coolant line 21. The coolant line 21 is provided with a water-supplying pump 22. The turbine 18 is connected to a generator 23, and the condenser 19 is connected to a water-intake line 24 and a discharge line 25 through which a cooling water (seawater, for example) is supplied and discharged. The steam generated by the steam generators 13 is transferred to the turbine 18 through the coolant lines 20. The steam drives the turbine 18 to cause the generator 23 to generate electricity. After driving the turbine 18, the steam is cooled by the condenser 19 and is then returned to the steam generators 13 through the coolant line 21.

As shown in FIG. 5, the PWR 12 includes a reactor vessel 31 that is constituted of a reactor-vessel main body 32 and a reactor-vessel head 33 attached to an upper portion of the reactor-vessel main body 32. The reactor-vessel head 33 can be opened and closed with respect to the reactor-vessel main body 32 such that components can be inserted in the reactor vessel 31. The reactor-vessel main body 32 is cylindrical and has an open upper portion and closed lower portion. The reactor-vessel main body 32 includes a heat shield 34 fixed to an internal surface thereof, an inlet nozzle 35, and an outlet nozzle 36 that are formed in an upper portion of the reactor-vessel main body 32. Through the inlet and outlet nozzles, the primary coolant is supplied and discharged

A reactor core 39 in the reactor-vessel main body 32 is positioned between upper and lower core plates 37 and 38 and houses therein a number of fuel assemblies 40. The reactor core 39 is divided into three or four symmetrical areas in view of a replacement order of the fuels. In other words, when the rector core 39 is divided into four areas of, for example, an area for new fuels, an area for fuels after first-cycle irradiation, an area for fuels after second-cycle irradiation, and an area for fuels after third-cycle irradiation, the areas are adjacent at 90 degrees in a plan view of the reactor core 39. An upper support plate 42 is connected to an upper portion of the upper core plate 37 via columns 41 and thus fixed, and the upper support plate 42 and the upper core plate 37 support a number of control-rod-cluster guide tubes 43 in between. The reactor vessel head 33 supports a control-rod drive mechanism 45. A control-rod-cluster driveshaft 46 extends down to and reach the fuel assembly 40 through the control-rod-cluster guide tube 43, and a control rod cluster (control rod) 47 is attached to a lower portion of the control-rod-cluster driveshaft 46.

Meanwhile, a lower support plate 48 is fixed to a lower portion of the lower core plate 38 and supports instrumentation guide thimbles 49.

The control-rod drive mechanism 45 moves the control rod cluster 47 so that the control rod (not shown) is inserted into the fuel assembly 40, thereby controlling the nuclear fission inside the reactor core 39. Heat energy generated by the nuclear fission heats up the primary coolant with which the inside the reactor vessel 31 is filled. The resultant high-temperature primary coolant is discharged from the outlet nozzle 36 and transferred to the steam generators 13 as described above. More specifically, uranium or plutonium employed as the fuels in the fuel assembly 40 undergoes fission to release neutrons. The light water that serves as the neutron moderator and the primary coolant decreases the kinetic energy of released fast neutrons so that the fast neutrons are turned into thermal neutrons. Accordingly, nuclear fission is promoted and the generated heat is removed to cool the fuels. The number of neutrons generated in the reactor core 39 is controlled by the insertion of the control rod cluster 47 into the fuel assembly 40. In case an emergent shutdown of the PWR 12 is required, the control rod cluster 47 is rapidly inserted into the fuel assembly 40.

As shown in FIG. 6, the nuclear reactor housing 11 is constructed on a hard ground 51 such as rock and is compartmentalized with walls made of, for example, reinforced concrete. The walls form a cylindrical concrete structure 54 and the concrete structure is positioned at the center of the nuclear reactor housing 11 such that an upper compartment 52, a steam-generator loop chamber 53, and the like are formed. The concrete structure 54 supports and hangs the PWR 12 (reactor vessel 31). The PWR 12 disposed in the upper compartment 52 and the steam generators 13 disposed in the steam-generating loop chamber 53 are connected via the coolant lines 14 and 15.

Because of the concrete structure 54, a cavity 55 is formed below the reactor vessel 31. A drain line 56 extends from the steam-generator loop chamber 53 and reaches the cavity 55. The nuclear reactor housing 11 further includes a cooling-water supply line 57 that supplies water for extinction to fill the cavity 55. The end of the cooling-water supply line 57 is connected to the water supplier 58, and the other end extends to and reaches the cavity 55.

As shown in FIGS. 1 to 3, the nuclear reactor housing 11 according to the first embodiment includes a supporting member 61 and a granulating member 62 that are positioned between the PWR 12 and the cavity 55. The supporting member 61 is configured to temporarily support a portion of the reactor vessel 31 that separates and falls from the PWR 12 in case an accident occurs. The granulating member 62 that servers as a granulation accelerating unit is configured to granulate a molten material (hereinafter, “debis”) that falls from the PWR 12. A granule of the granulated debris in the exemplary embodiments of the present invention may be any size including a baseball size and a marble size.

The supporting member 61 is constituted of a plurality of supporting bars 61a that are assembled in a matrix. In this manner, the supporting member 61 is configured to temporarily support a portion of the reactor vessel 31 that separates and falls from the PWR 12. The supporting member 61 has a plurality of through holes 61b through which the debris from the reactor vessel 31 falls. Meanwhile, the granulating member 62 is curved downward and has a plurality of through-holes 62a whose center axes are radial and fan out downward. In other words, the granulating member 62 has the through holes 62a along normal lines.

The edges of the supporting bars 61a are buried in the side wall of the concrete structure 54 so that the supporting member 61 is supported and has a strength enough to support a portion of the reactor vessel 31 separating and falling from the WPR 12 (for example, 300 tones). Similarly, the outer periphery of the granulating member 62 is buried in the side wall of the concrete structure 54, and thus, the granulating member 62 is supported. The granulating member 62 is made of a material having a melting point higher than the temperature of the debris of about 2800° C. It is preferable that the dividing means 62 be made of, for example, zirconium boride (ZrB2), tungsten carbide (WC), or titanium carbide (TiC).

When loss of coolant accident (LOCA) or transient occurs in the nuclear reactor housing 11, an emergency-core-cooling system operates to cool the reactor so that generated heat is sufficiently removed. However, when the emergency-core-cooling system breaks down, the PWR 12 cannot be cooled so that the reactor core inside the reactor vessel 31 melts and the resultant debris melts the reactor vessel 31 and falls.

Once the heat from the debris damages the bottom portion of the reactor vessel 31 and thus the bottom portion separates from the PWR 12 and falls, the supporting member 61 receives and supports the bottom portion having debris therein. Thereafter, the debris melts the bottom portion on the supporting member 61 and the resultant debris falls from the through holes 61b so that the granulating member 62 receives the debris. The debris is then granulated through the through holes 62a and falls radially into the cavity 55.

The cavity 55 is previously filled with cooling water from the drain line 56 or the cooling-water supply line 57, and thus, the cooling water removes the heat from the granulated debris in the cavity 55 in case LOCA occurs. Because the debris is granulated by the granulating member 62 and then falls radially into the cavity 55, the resultant granules are cooled quickly in the cooling water so that the granules can be prevented from getting combined again.

As described, the nuclear reactor housing 11 according to the first embodiment includes the cylindrical concrete structure 54, the PWR 12, the steam generators 13, and the cavity 55, where the concrete structure 54 supports the PWR 12 vertically, each of the steam generators 13 is connected to the PWR 2, the cavity 55 is positioned below the PWR 12. The nuclear reactor housing 11 further includes the granulating member 62 that is positioned between the PWR 12 and the cavity 55 and that is configured to granulate debris falling from the PWR 12.

The granulating member 62 receives the debris and granulates the debris via the through holes 62a so that granulation of the debris is accelerated while the resultant granules fall into the cavity 55. The resultant granules are cooled by the cooling water in the cavity 55. In this manner, the debris can be appropriately granulated and cooled quickly so that the safety of the nuclear power plant can be improved.

According to the first embodiment, the granulating member 62 has a plurality of through holes 62a and it granulates the debris. Thus, the debris can be granulated easily and cooled quickly with a simple structure. In addition, because the granulating member 62 is curved downward and has a plurality of through-holes 61b whose center axes are radial and fan out downward, debris is granulated and falls radially via the through holes 62a. In this manner, the granulation of debris can be accelerated.

The nuclear reactor housing 11 according to the first embodiment further includes the supporting member 61 that is positioned between the PWR 12 and the granulation member 62 and that is configured to temporarily support a portion of the reactor vessel 31 separating and falling from the PWR 12. Once the portion temporarily supported by the supporting member 61 melts into debris and falls from the supporting member 61, the granulating member 62 granulates the debris and thus the resultant granules fall into the cavity 55. In this manner, the portion doe not directly reach the granulating member 62, and thus, the granulating member 62 can be prevented from being damaged.

In addition, the supporting member 61 has the through holes 61b. When the supporting member 61 temporarily supports a portion of the reactor vessel 31 that separates and falls from the WPR 12 and then the debris in the portion melts the portion, the resultant debris falls to the granulating member 62 via the through holes 61b. In this manner, relatively large debris does not fall to the granulating member 62, and thus, the granulating member 62 can be prevented form being damaged.

The supporting member 61 is constituted of the supporting bars 61a that are assembled in a matrix and whose edges are buried in the side wall of the concrete structure 54. The outer periphery of the granulating member 62 is buried in the side wall of the concrete structure 54. In this manner, the supporting member 61 and the granulating member 62 can be supported easily without any other member, and thus, the cost reduction can be achieved.

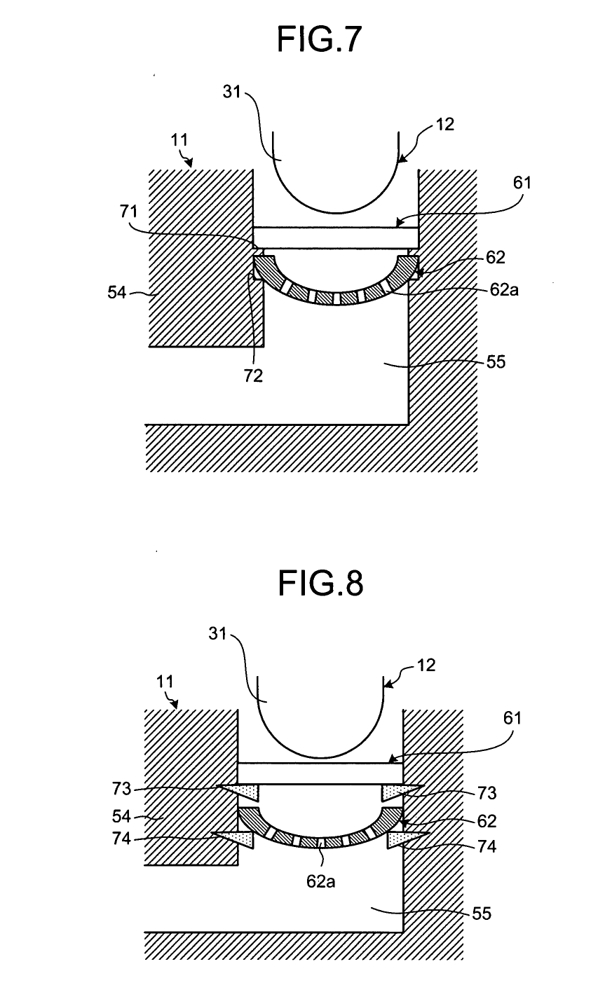

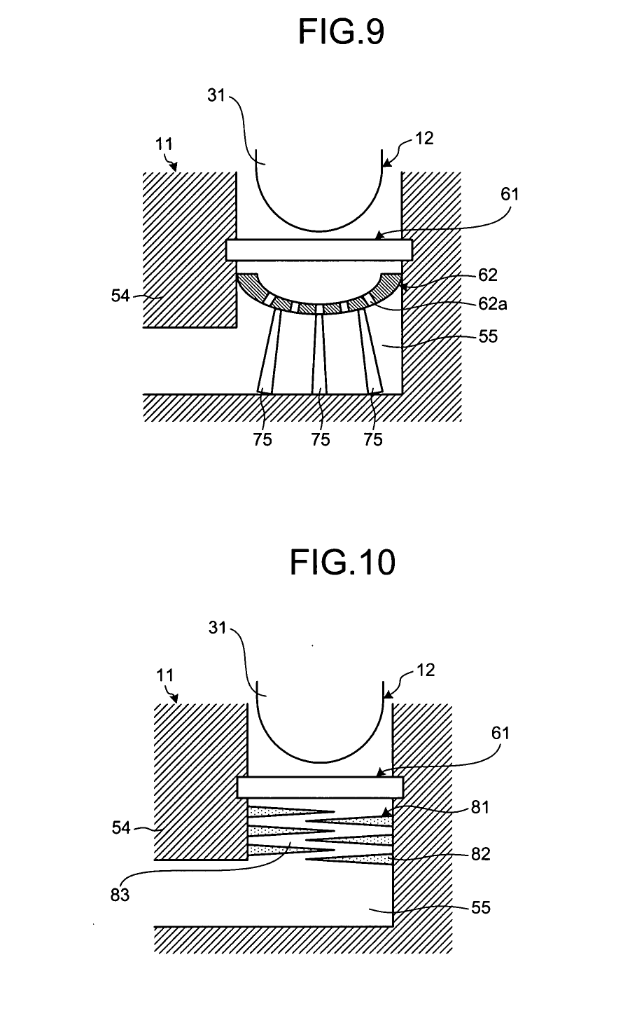

FIG. 7 is a schematic side view of a granulation accelerating device according to a second embodiment of the present invention that is employed for a nuclear reactor housing. FIGS. 8 and 9 are schematic side views of modifications of the structure that supports the granulation accelerating device shown in FIG. 7. Same reference numerals as those of the first embodiment denote the members of the second embodiment that function as the members of the first embodiment do, and the descriptions thereof are omitted below.

As shown in FIG. 7, the nuclear reactor housing 11 includes the supporting member 61 that is positioned between the PWR 12 and the cavity 55 and that is configured to temporarily support a portion of the nuclear vessel 31 separating and falling from the PWR 12; and the granulating member 62 that granulates debris, that falls from the PWR 12, to accelerates granulation of the debris.

The supporting member 61 is constituted of the supporting bars 61a that are assembled in a matrix. In this manner, the supporting member 61 is configured to temporarily support a portion of the reactor vessel 31 separating and falling from the PWR 12. The supporting member 61 has the through holes 61b through which the debris from the reactor vessel 31 falls. Meanwhile, the granulating member 62 is curved downward and has a plurality of through-holes 62b whose center axes are radial and fan out downward.

The concrete structure 54 includes ring-shaped upper and lower flanges 71 and 72 that are separated with a certain interval on a side wall of the concrete structure. The supporting member 61 is supported in a way that the edges of the supporting members 61a are on the upper flange 71, and the granulating member 62 is supported by the lower flange 72 in a way that the outer periphery of the granulating member 62 is on the lower flange.

The structure that supports the supporting member 61 and the granulating member 62 are not limited to the one described above. For example, as shown in FIG. 8, the concrete structure 54 can include a plurality of upper wedge-shaped holding pieces 73 that are fixed to the side wall thereof along the circumferential direction and are separated with certain intervals; and a plurality of lower wedge-shaped holding pieces 74 that are fixed to and separated on the side wall in the same manner. The supporting member 61 is supported in a way that the edges of the supporting members 61a are on the upper wedge-shaped holding pieces 74, and the granulating member 62 is supported in a way that the outer periphery of the granulating member 62 are on the lower wedge-shaped holding pieces 74. The upper and lower wedge-shaped holding pieces 73 and 74 may be in any form, for example, may be fan-shaped or circular. Alternatively, as shown in FIG. 9, a plurality of legs 75 that stands on the bottom of the cavity 55 may be formed such that legs 75 support the bottom surface of the granulating member 62.

In case LOCA or transient occurs in the nuclear reactor housing 11 but an emergency-core-cooling system breaks down, the core inside the nuclear vessel 31 melts into debris. Once heat from debris damages the bottom portion of the reactor vessel 31 and the bottom portion separates and falls from the PWR 12, the supporting member 61 receives and supports the bottom portion. The debris in the bottom portion on the supporting member 61 melts the bottom portion and the resultant debris falls from the through holes 61b so that the granulating member 62 receives the debris. Thereafter, the debris is granulated via the through holes 62a and fall radially into the cavity 55.

The cavity 55 is previously filled with cooling water that is supplied from the drain line 56 or the cooling-water supply line 57. Because the debris is granulated and then heat of the resultant granules is removed by the cooling water, the granules are prevented from getting combined again.

As described, the nuclear reactor housing 11 according to the second embodiment includes the cylindrical concrete structure 54, the PWR 12, and the cavity 55, where the concrete structure 54 supports the PWR 12 vertically and the cavity 55 is positioned below the PWR 12. The nuclear reactor housing 11 further includes the supporting member 61 that is configured to temporarily support a portion of the reactor vessel 31 separating and falling from the PWR 12; and the granulating member 62 that is configured to granulate debris falling from the PWR 12, the supporting member 61 and the granulating member 62 being positioned between the PWR 12 and the cavity 55.

Once the bottom portion of the reactor vessel 31 that is temporarily supported by the supporting member 61 melts into debris and falls, the granulating member 62 receives the debris and granulates the debris via the through holes 62a. In this manner, the debris falls into the cavity 55 while the granulation of the debris is accelerated. The heat of the resultant granules is removed by the cooling water in the cavity 55. Accordingly, the debris can be appropriately granulated and can be cooled quickly, and thus, safety of the nuclear power plant can be improved.

The supporting member 61 and the granulating member 62 are supported by the flanges 71 and 72 according to the second embodiment that are simply integrally formed on the side wall of the concrete structure 54. In this manner, the supporting member 61 and the granulating member 62 can be easily installed in the nuclear reactor housing 11. Accordingly, the efficiency of the construction of the nuclear reactor housing 11 can be improved.

The supporting member 61 and the granulating member 62 are supported by the holding pieces 73 and 74 according to the second embodiment that are simply fixed to the side wall of the concrete structure 54 previously. In this manner, the supporting member 61 and the granulating member 62 can be easily installed in the nuclear reactor housing 11. Accordingly, the efficiency of the construction of the nuclear reactor housing 11 can be improved.

The legs 7 according to the second embodiment stand on the bottom of the cavity 55 and support the granulating member 62, and thus, the processing the side wall of the concrete structure 54 is not proceeded. In this manner, the granulating member 62 can be easily installed in the nuclear reactor housing 11.

FIG. 10 is a schematic view of a granulation accelerating device according to a third embodiment of the present invention that is employed for a nuclear reactor housing. Same reference numerals as those of the first and second embodiments denote the members of the third embodiment that function as the members of the first and second embodiment do, and the descriptions thereof are omitted below.

As shown in FIG. 10, the nuclear reactor housing 11 includes the supporting member 61 configured to support a portion of the reactor vessel 31 that falls and separates from the PWR 12; and the granulating member 81 that includes a unit configured to granulate debris falling from the PWR 12 to accelerate the granulation of the debris, the supporting member 61 and the granulating member 81 being positioned between the PWR 12 and the cavity 55.

The granulating member 81 consists of a spiral plate 82 that forms a spiral path and whose outer periphery is fixed to and supported by the concrete structure 54. The plate is wedge-shaped and the inner periphery thereof slants downward.

The structure that supports the granulating member 81 is not limited to the one described above. For example, a flange may be integrally formed on the side wall of the concrete structure 54 to support the outer periphery of the granulating member 81. Alternatively, wedge-shaped holding pieces may be fixed to the side wall to support the outer periphery of the granulating member 81. Alternatively, legs that stand on the bottom of the cavity 55 may support the granulating member 81.

In case LOCA or transient occurs in the nuclear reactor housing 11 but an emergency-core-cooling system breaks down, the core inside the nuclear vessel 31 melts into debris. Once heat from debris damages the bottom portion of the reactor vessel 31 and the bottom portion separates and falls from the PWR 12, the supporting member 61 receives and supports the bottom portion. The debris in the bottom portion on the supporting member 61 melts the bottom portion and the resultant debris falls so that the upper surface of the granulation member 81 receives the debris. Thereafter, the debris spirally moves on the spiral plate 82 while being in contact with the inner periphery of the spiral plate 82 so that the debris can be granulated and falls into the cavity 55.

The cavity 55 is previously filled with cooling water that is supplied from the drain line 56 or the cooling-water supply line 57. Because the debris is granulated and then heat of the resultant granules is removed by the cooling water, the granules are prevented from getting combined again.

As described, the nuclear reactor housing 11 according to the third embodiment includes the cylindrical concrete structure 54, the PWR 12, and the cavity 55, where the concrete structure 54 supports the PWR 12 vertically and the cavity 55 is positioned below the PWR 12. The nuclear reactor housing 11 further includes the supporting member 61 configured to temporarily support a portion of the reactor vessel 31 separating and falling from the PWR 12; and the granulating member 81 configured to granulate debris falling from the PWR 12, the supporting member 61 and the granulating member 81 being positioned between the PWR 12 and the cavity 55.

Once the bottom portion of the reactor vessel 31, that is temporarily supported by the supporting member 61, melts into debris and falls, the granulating member 81 receives the debris and the debris spirally moves on the spiral plate 82 while being in contact with the inner periphery of the spiral plate 82 so that the debris can be granulated while falling into the cavity 55. The heat of the resultant granules is removed by the cooling water in the cavity 55. In this manner, the debris can be appropriately granulized and cooled, and thus, the safety of the nuclear power plant can be improved.

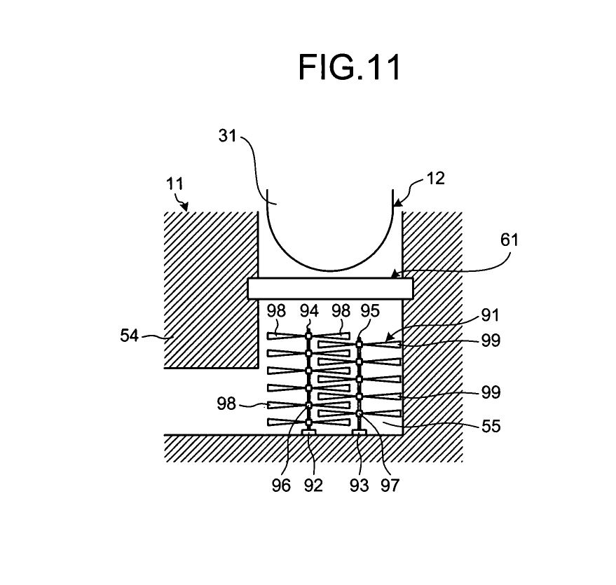

FIG. 11 is a schematic view of a granulation accelerating device according to a fourth embodiment of the present invention that is employed for nuclear reactor housing. Same reference numerals as those of the first to third embodiments denote the members of the fourth embodiments that function as the members of the first to third embodiments do, and the descriptions thereof are omitted below.

As shown in FIG. 11, the nuclear reactor housing 11 includes the supporting member 61 configured to temporarily support a portion of the reactor vessel 31 that separates and falls from the PWR 12; and stirring wings 91, each stirring wing including a granulating unit configured to granulate debris falling from the PWR 12 to accelerates granulation of the debris, the supporting member 61 and the stirring wings 91 being positioned between the PWR 12 and the cavity 55.

The stirring wings 91 include bases 92 and 93, shafts 94 and 95, receiving members 96 and 97, and a plurality of wings 98 and 99. The base 92 supports the shaft 94 and the base 93 supports the shaft 95 so that the shafts 94 and 95 stand on the bottom of the cavity 55. The wings 98 are attached to the shaft 94 with the receiving members 96, and the wings 99 are attached to the shaft 95 with the receiving members 97. Accordingly, the wings 98 and 99 are configured to rotate on the vertical rotating axis in accordance with the falling of debris from the PWR 12.

In case LOCA or transient occurs in the nuclear reactor housing 11 but an emergency-core-cooling system breaks down, the core inside the nuclear vessel 31 melts into debris. Once heat from debris damages the bottom portion of the reactor vessel 31 and the bottom separates and falls from the PWR 12, the supporting member 61 receives and supports the bottom portion. The debris in the bottom portion on the supporting member 61 melts the bottom portion and the resultant debris falls and reaches the stirring wings 91. The stirring wings 91 rotate in accordance with the falling of debris so that the debris can be granulated by the wings 88 and 99 and falls into the cavity 55.

The cavity 55 is previously filled with cooling water that is supplied from the drain line 56 or the cooling-water supply line 57. Because the debris is granulated and then heat of the resultant granules is removed by the cooling water, the granules are prevented from getting combined again.

The nuclear reactor housing 11 according to the fourth embodiment includes the cylindrical concrete structure 54, the PWR 12, and the cavity 55, where the concrete structure 54 supports the PWR 12 vertically and the cavity 55 is positioned below the PWR 12. The nuclear reactor housing 11 further includes the supporting member 61 configured to temporarily support a portion of the reactor vessel 31 separating and falling from the PWR 12; and the stirring wings 91 configured to granulate debris falling from the PWR 12, the supporting member 61 and the stirring wings 91 being positioned between the PWR 12 and the cavity 55.

Once the bottom portion of the reactor vessel 31 that is temporarily supported by the supporting member 61 melts into debris and falls, the debris reaches stirring wings 91 and the debris is granulated by the wings 98 and 99 and falls into the cavity 55. The heat of the resultant granules is removed by the cooling water in the cavity 55. In this manner, the debris can be appropriately granulized and cooled, and thus, the safety of the nuclear power plant can be improved.

According to each of the first to fourth embodiments, the supporting member 61 and a corresponding one of the granulating members 62 and 81 and the stirring wings 91 are provided between the PWR 12 and the cavity 55. However, the configuration is not limited to this. For example, only any one of the granulating members 62 and 81 can be provided without the supporting member 61. Each of the granulating members 62 and 81 can serve as the supporting member 61 when enough strength of the granulating member is assured.

Descriptions are provided above for the granulation accelerating device that accelerates granulation of debris and the nuclear reactor housing according to each of the first to fourth embodiments that are employed for pressurized water reactors. However, the granulation accelerating device and the nuclear reactor housing can be employed for any nuclear reactor that uses light water such as a boiling water reactor (BWR).

According to an aspect of the present invention, granulation of debris is efficiently accelerated and the debris can be cooled quickly. According to another aspect of the present invention, the granulating member can be easily installed in the nuclear reactor housing. According to still another aspect of the present invention, the costs of the nuclear rector housing can be reduced. According to still another aspect of the present invention, safety of the nuclear power plant can be improved. According to still another aspect of the present invention, efficiency of construction of the nuclear reactor housing can be improved.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A granulation accelerating device comprising a granulating unit that is positioned between a nuclear reactor and a cavity and that is configured to granulate debris that falls from a nuclear reactor into the cavity.

2. The granulation accelerating device according to claim 1, wherein the granulating unit includes a granulating member having a plurality of through holes through which the granulated debris falls into the cavity.

3. The granulation accelerating device according to claim 2, wherein the granulating member is curved downward and center axes of the through holes are radial and fan out downward.

4. The granulation accelerating device according to claim 1, further comprising a supporting member that is positioned between the nuclear reactor and the granulating unit and that is configured to support a portion of a reactor vessel that separates and falls from the nuclear reactor.

5. A nuclear reactor housing comprising:
a nuclear reactor;
a cavity located below the nuclear reactor; and
a granulation accelerating unit that is positioned between the nuclear reactor and the cavity and that is configured to accelerate granulation of debris that falls from the nuclear reactor.

6. The nuclear reactor housing according to claim 5, wherein the granulation accelerating unit includes a granulating member having a plurality of through holes.

7. The nuclear reactor housing according to claim 6, wherein the granulating member is curved downward and center axes of the through holes are radial and fan out downward.

8. The nuclear reactor housing according to claim 6, further comprising a concrete structure that has a side wall, wherein
the granulating member has an outer periphery that is buried in the side wall such that the granulating member is supported.

9. The nuclear reactor housing according to claim 6, further comprising:
a concrete structure that has a side wall; and
a flange that is integrally formed in the side wall, wherein
the granulation accelerating unit has an outer periphery that rests on the flange such that the granulating member is supported.

10. The nuclear reactor housing according to claim 6, further comprising:
a concrete structure that has a side wall; and
a holding member that is fixed to the side wall, wherein
the granulating member has an outer periphery that rests on the holding member such that the granulating member is supported.

11. The nuclear reactor housing according to claim 6, further comprising a plurality of legs each of which stands on a bottom of the cavity and supports the granulating member.

12. The nuclear reactor housing according to claim 5, wherein the granulation accelerating unit includes a granulating member that includes a spiral path.

13. The nuclear reactor housing according to claim 12, further comprising a concrete structure, wherein
the granulating member is a spiral plate that has an outer periphery supported by the concrete structure and that has an inner periphery that slants downward.

14. The nuclear reactor housing according to claim 5, wherein the granulation accelerating unit includes a plurality of stirring wings, each stirring wing having a vertical rotation axis.

15. The nuclear reactor housing according to claim 14, wherein the stirring wings are configured to rotate in accordance with falling of the debris.

16. The nuclear reactor housing according to claim 5, wherein the nuclear reactor includes a reactor vessel, the nuclear reactor housing further comprising a supporting member that is positioned between the nuclear reactor and the granulation accelerating unit and that is configured to support a portion of the reactor vessel that separates and falls from the nuclear reactor.

17. The nuclear reactor housing according to claim 16, wherein the supporting member has though holes through which the debris falls.
